(19) United States
(12) Patent Application Publication
(10) Pub. No.: US 2012/0142372 A1
(43) Pub. Date: Jun. 7, 2012

(54) Method and Device for Updating the Date and Time of an Electronic System, in Particular a Cellular Mobile Telephone

(75) Inventor: Arnaud Rosay, Voivres Les Le Mans (FR)

(73) Assignee: ST-ERICSSON SA, Plan-les-Ouates (CH)

(21) Appl. No.: 13/318,534

(22) PCT Filed: May 3, 2010
(86) PCT No.: PCT/EP2010/055961

§ 371 Date: Feb. 22, 2012

(30) Foreign Application Priority Data
May 5, 2009 (FR) 0952989

(51) Int. Cl. H04W 24/00

(52) U.S. Cl. 455/456.1

(57) ABSTRACT

Device for updating the date and time of an electronic system, said device comprising connection means for connecting the electronic system with an assisted global positioning system, recovery means for recovering assistance data emitted by the assisted global positioning system, determination means for determining the current date and time of the electronic system based on said recovered assistance data, and control means capable of activating the connection, recovery and determination means.

The invention relates to the updating of the date and time of an electronic system.

The invention applies advantageously but in a non-limiting way to a wireless communication appliance, such as a cellular mobile telephone.

Currently, mobile phones display the date and time on a screen and the user must update this time data when using his telephone for the first time. Once the telephone is started up, the date and time are regularly updated using a circuit, called RTC (Real Time Clock), which manages the real time clock of the telephone. However, this circuit operates as long as it is powered. In practice, when the RTC is no longer powered, the date and time are lost.

A backup battery can be added to the telephone, so that, when the main battery is drained, or is removed from the telephone, the RTC continues to be powered by the backup battery. Furthermore, if the main battery is replaced before the backup battery is drained, the telephone can display the correct date and time when the telephone is next started up. There are also capacitors that have high capacities that can be used as backup batteries. However, when the telephones are not equipped with such a backup battery and the RTC is no longer powered, it is the user who must update, once again, the date and time of his telephone when the latter is next started up. Such is the case for most inexpensive telephones.

The international application WO 2006/000981 discloses a method for updating the date and time of a communication appliance using communication frames emitted from a radio station. This method is based on a count of the number of frames received since a time when the RTC power supply was stopped. However, this method works only if the telephone is no longer powered for, at best, a time of 3 hours 28 minutes and 53 seconds. Beyond this time, the date and time are lost. Moreover, this method comprises a specific step in which the current date and time and the number of the last frame exchanged are stored in memory when the main battery is drained or changed, in order to be able to correct the date and time of the telephone when the latter is started up again.

According to one implementation and embodiment, there is proposed a method and a device for updating the date and time of an electronic system, notably a wireless communication appliance, automatically without the user having to do the update procedure. Such an electronic system can be a computer, portable or not, or any other electronic system requiring a correct current date and time to be displayed.

According to another implementation and embodiment, there is proposed an automated updating that can work even after a prolonged stoppage of the power supply to the electronic system.

According to one aspect, there is proposed a method of updating the date and time of an electronic system.

This method comprises a connection with an assisted global positioning system, a recovery of assistance data emitted by the assisted global positioning system and a determination of the current date and time of the electronic system based on said recovered assistance data.

Thus, it is possible to recover the date and time independently of the level of charge of the battery, or of the backup batteries, of the electronic system. The assisted global positioning system, also called A-GPS, differs from the conventional global positioning system (GPS) in as much as a cellular mobile telephone can send an assistance request to the assisted global positioning system to more rapidly decode the signals from the satellites and to more effectively find the geographic position of the telephone.

Furthermore, it is possible to update the time data of the electronic system without having to use a backup battery. The volume and the manufacturing costs of such an electronic system are thus reduced.

Advantageously, the recovery of assistance data includes a recovery of the number of the current week and of the current time of said current week.

A simple and precise method for updating the current date and time is thus provided.

In one implementation, the updating of the date and time of the electronic system is performed when the electronic system is started up.

Thus, it is possible to perform the updating of the date and time only when the electronic system is started up, which makes it possible to save on the processing operations for connection with the assisted global positioning system.

In another implementation, the updating of the date and time of the electronic system can also be performed periodically.

In this implementation, it is possible to update the time data of the electronic system regularly to limit the time drifts on the date and time.

According to another aspect, there is proposed a device for updating the date and time of an electronic system.

This device comprises connection means for connecting the electronic system with an assisted global positioning system, recovery means for recovering assistance data emitted by the assisted global positioning system, determination means for determining the current date and time of the electronic system based on said recovered assistance data, and control means capable of activating the connection, recovery and determination means.

Advantageously, the recovery means are capable of recovering a number of the current week and a current time of said current week.

According to one embodiment, the control means are capable of activating the connection, recovery and determination means when the electronic system is started up.

According to another embodiment, the control means are capable of periodically activating the connection, recovery and determination means.

According to another aspect, there is also proposed an electronic system comprising means of supplying the date and time and a device for updating the date and time as defined hereinabove.

According to one embodiment, the electronic system can be a wireless communication appliance.

Other advantages and characteristics will become apparent from studying the detailed description of implementations and embodiments of the invention, which are by no means limiting, and the appended drawings in which:

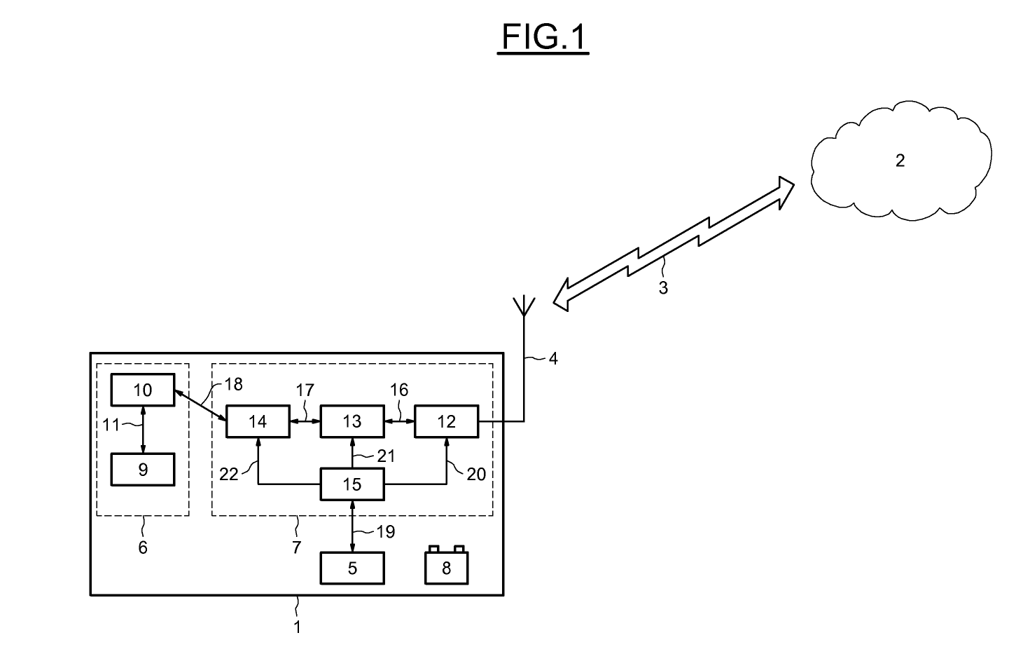

FIG. 1 illustrates one embodiment of an electronic system provided with a device for updating the date and time of the electronic system; and

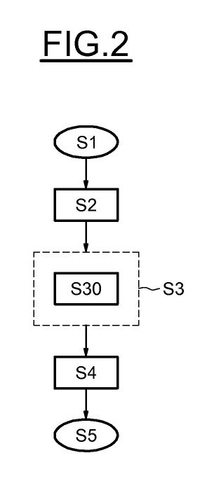

FIG. 2 illustrates one implementation of a method of updating the date and time of an electronic system.

FIG. 1 diagrammatically shows an electronic system 1, for example a wireless communication appliance, such as a cellular mobile telephone, capable of communicating, in receive and transmit modes, with an assisted global positioning system 2 via radio signals 3.

The assisted global positioning system 2 can be used to transmit assistance data to the connected subscribers. These assistance data can be differential correction data for correcting the positions of the satellites. From these assistance data, the assisted global positioning system can also transmit GPS TOW (Time Of Week) data, that make it possible to supply the current date and time with an accuracy of two seconds. The GPS TOW data are a combination of the number of the current week, between 1 and 53, and the current time in this week. The current time of a week, expressed in seconds, corresponds to the number of seconds elapsed in the current week since Sunday midnight, that is to say, in the night between Sunday and Monday, on the GPS time scale. This current time of the week is between 0 and 604800 seconds.

The electronic system 1 comprises an antenna 4 for receiving and transmitting data with the assisted global positioning system 2. This electronic system 1 further comprises an electronic control unit 5 (ECU), means of supplying the date and time 6, a device for updating the date and time 7 of the electronic system 1 and a power supply unit 8.

The means of supplying the date and time 6 include a clock management means 9 and a display means 10.

The clock management means 9 can be, for example, an RTC for regularly updating the date and time of the electronic system 1. This clock management means 9 is powered by the power supply unit 8. The power supply unit 8 is also capable of powering the various elements 5 to 7 of the electronic system 1. The clock management means 9 is further capable of transmitting a current date and time, via a connection 11, to the display means 10 as long as the clock management means 9 is powered by the power supply unit 8.

The display means 10 is capable of displaying the current date and time of the electronic system 1.

The device for updating the date and time 7 of the electronic system 1 comprises connection means 12, recovery means 13, determination means 14 and control means 15.

The connection means 12 are capable of connecting the electronic system 1 with the assisted global positioning system 2, via the antenna 4, so that the electronic system 1 can receive assistance data from the assisted global positioning system 2. Then, these connection means 12 transmit the received assistance data, via a connection 16, to the recovery means 13.

The recovery means 13 are capable of recovering the GPS TOW data from the received assistance data and transmitting, via a connection 17, said GPS TOW data to the determination means 14.

The determination means 14 are capable of determining the current date and time, based on the GPS TOW data, and of transmitting them, via a connection 18, to the display means 10.

The control means 15 are capable of activating or deactivating, via the connections 20 to 22, respectively the connection 12, recovery 13 and determination 14 means.

The ECU 5 controls the various electronic computation units of the electronic system 1, and in particular the device for updating the date and time 7. The ECU 5 emits commands, transmitted via a connection 19, to the control means 15 of the updating device 7.

According to one embodiment, the control means 15 activate the connection 12, recovery 13 and determination 14 means of the updating device 7, only each time the electronic system 1 is started up, then the clock management means 9 periodically updates the date and time of the electronic system 1. In this case, a multitude of connections with the assisted global positioning system 2 are thus avoided.

According to another embodiment, the control means 15 can periodically activate the connection 12, recovery 13 and determination 14 means of the updating device 7 in parallel with the periodic updating performed by the clock management means 9. Thus, it is possible to make additional connections with the assisted global positioning system 2 in order to obtain a better accuracy on the current date and time. Time drifts on the date and time of the electronic system 1 are thus avoided.

It is also possible to envisage another embodiment in which the control means 15 activate the connection 12, recovery 13 and determination 14 means of the updating device 7, based on a command emitted from the ECU 5 according to a date and time management algorithm to update the date and time according to the requirements of the electronic system 1.

Furthermore, the control means 15 can be controlled by the ECU 5 or have their own autonomy, for example when the control means 15 include a date and time management algorithm, to control the connection 12, recovery 13 and determination 14 means of the updating device 7.

The updating device 7 can be implemented in the electronic system 1 in software form and/or in logic circuit form.

More particularly, when the electronic system 1 is a cellular mobile telephone, some means of the device 7 can be produced by software modules directly incorporated in the baseband processor of the telephone. Other means can be produced by specific components, software or otherwise, and/or at least partly use the components of the telephone's transmission and/or reception subsystems.

FIG. 2 diagrammatically shows the main steps of a method of updating the date and time of an electronic system. This method can be implemented in the device 7 described previously in FIG. 1, or else in the ECU 5 of the electronic system 1.

The method comprises a step S1 for starting up the electronic system 1, then a step S2 for connecting with the assisted global positioning system 2. This connection step S2 is then followed by a step S3 for recovering the assistance data emitted by the assisted global positioning system 2. This recovery step S3 comprises a step S30 for recovery of the GPS TOW data from said assistance data. Then, the recovery step S3 is followed by a determination step S4 for determining the current date and time of the electronic system 1 based on said recovered assistance data. After this determination step S4, a step S5 for updating the date and time with the determined current date and time is performed.

In one implementation, the steps for updating the date and time of the electronic system, namely the connection S2, recovery S3, determination S4 and updating S5 steps, are performed only each time the electronic system is started up.

In another implementation, the steps for updating the date and time of the electronic system, namely the connection S2, recovery S3, determination S4 and updating S5 steps, are performed periodically according to a reference period.

It is also possible to envisage, in another implementation, performing the steps for updating the date and time of the electronic system, namely the connection S2, recovery S3, determination S4 and updating S5 steps, according to the requirements of the electronic system.

1. A method of updating the date and time of an electronic system, comprising a connection with an assisted global positioning system, a recovery of assistance data emitted by the assisted global positioning system and a determination of the current date and time of the electronic system based on said recovered assistance data.

2. The method according to claim 1, wherein the recovery of assistance data includes a recovery of the number of the current week and of the current time of said current week.

3. The method according to claim 1, wherein the updating of the date and time of the electronic system is performed when the electronic system is started up.

4. The method according to claim 1, wherein the updating of the date and time of the electronic system is performed periodically.

5. A device for updating the date and time of an electronic system, comprising connection means for connecting the electronic system with an assisted global positioning system, recovery means for recovering assistance data emitted by the assisted global positioning system, determination means for determining the current date and time of the electronic system based on said recovered assistance data, and control means capable of activating the connection, recovery and determination means.

6. The device according to claim 5, wherein the recovery means are capable of recovering a number of the current week and a current time of said current week.

7. The device according to claim 5, wherein the control means are capable of activating the connection, recovery and determination means when the electronic system is started up.

8. The device according to claim 5, wherein the control means are capable of periodically activating the connection, recovery and determination means.

9. An electronic system comprising means of supplying the date and time and a device for updating the date and time of the electronic system according to claim 5.

10. The electronic system according to claim 9, forming a wireless communication appliance.
